(19) United States
(12) Patent Application Publication
(10) Pub. No.: US 2011/0106720 A1
(43) Pub. Date: May 5, 2011

(54) EXPERT SYSTEM FOR GAP ANALYSIS

(76) Inventor: Jerome Dale JOHNSON, North Mankato, MN (US)

(21) Appl. No.: 12/613,515

(22) Filed: Nov. 5, 2009

(51) Int. Cl. G06Q 10/00; G06Q 50/00; G06F 15/18; G06N 5/02; G06F 17/30

(52) U.S. Cl. 705/342; 706/12; 706/54; 707/769; 707/E17.014

(57) ABSTRACT

An Expert System for analyzing a gap by determining a first parameter from a base document, a second parameter from a target document, a difference in magnitude between the first parameter and the second parameter, and a subject score as a function of the difference in magnitude and a subject importance.

### BACKGROUND OF THE INVENTION

1. Field of the Invention

This invention relates to an Expert System for analyzing at least one gap by determining a first parameter from a base document, a second parameter from a target document, a difference magnitude between the first parameter and the second parameter, and a subject score as a function of the difference magnitude and a subject importance.

2. Discussion of Background Information

Conventionally, analysis and comparison of information between two documents (a base document and a target document) has been a very time consuming and subjective task because documents generally contain different types of information with different organizational formats and often using different titles and terminology. The term “document” is used in a broad sense herein, and will include reference to electronic information stored in a database or to a page of printed material.

FIG. 1 illustrates a conventional method of analyzing documents. A user (for example, an insurance agent, a financial advisor, or an agricultural salesperson) may manually create a display or table incorporating portions of the base document (Document A) in a first column and portions of the target document (Document B) in a second column, in order to visually facilitate manual analysis by the user. The table may have multiple lines associated with multiple subjects. The term “manual,” in this context, means that the user must read and identify a portion (if it exists) in the base document associated with the first subject, and a portion (if it exists) in the target document associated with the first subject.

In order for the user to be certain that no portion associated with the first subject exists in the base document (known as proving a negative), the user must carefully read every single portion of the base document. This detailed reading is very time consuming, is subject to interpretation based on the agent's experience and educational background, and is prone to errors.

FIRST SCENARIO—INSURANCE AGENT In a first exemplary scenario, an insurance agent (the agent) wants to sell a business insurance policy (target document) to a potential client who owns a restaurant business (the owner). The owner is currently buying a business insurance policy (base document) from a competitor of the agent. Further, the owner is currently evaluating a new business insurance policy (target document) during the renewal period.

The term “agent” is used herein as an illustrative example of a user of an Expert System according to the present invention, wherein the agent can be a seller of insurance policies as discussed in the first scenario. Similarly, the term “owner” is used herein as an illustrative example of a potential client or an existing client or any entity that can benefit from an expert system for gap analysis as discussed below. Other scenarios, discussed below, include an insurance broker and an agricultural product salesman.

Conventionally, the agent is typically provided (by an insurance carrier, for example) with application forms and other tools from which a quote may be generated for a business insurance policy. However, before the quote can be created, the agent needs to convince the owner that it is “worth his time” to work with the agent, and convince the owner to actually and seriously consider another insurance policy. The owner may have an established, long-term relationship with an incumbent agent and insurance provider (the competitor). This established, long-term relationship between the owner and the competitor makes the situation difficult for the agent to break into and win the account. This situation can be made even more difficult if the agent is new to this industry, new to this market, new to this field, or has little or no knowledge of the owner's business. All of these factors make it difficult for the user to establish creditability with the owner.

In this first scenario, a “best practice” within the insurance industry is for the agent to request the current scenario which is best documented in the current business insurance policy (the base document) from the owner. This practice allows the agent to analyze the current policy and then make an offer to supply identical coverage at a lower price, which is a possibility that may interests the owner. The owner is typically curious regarding whether the competitor is overcharging the owner for the current business insurance policy (the base document), and an offer of identical coverage allows the owner to “check things out” (benchmark) and to keep the competitor “honest” (keep the competitor from overcharging the owner).

More importantly and more complexly, the base document (the current business insurance policy) may be analyzed for gaps in coverage and product features to a target document (a new business insurance policy provided by the agent). This gap analysis is complex and difficult to perform. Conventionally, an agent may spend a large amount of time performing the gap analysis. The policies generally have different structure, different terms are used from one policy to another, different format is used, and a simple one-to-one comparison between the policies is difficult.

It is a rare situation where an owner fully understands the current policy. Thus, the owner generally worries about questions such as, “What is in the fine print? What coverage do I really have? What risks do I really have?”

As shown in FIG. 1, a good agent may manually create a side-by-side chart listing features of the base document along-side of features of the target document. The target document may be, for example, a top-of-the line policy or best practices, known in the industry as the “gold standard.”

Using the table of FIG. 1, the agent may attempt to analyze the current policy to the proposed policy to clarify where the agent can add value and where the agent should focus his sales presentation and win the sale. For example, the gap analysis may determine that the current policy only covers a discrimination claim made by an employee, but does not cover a discrimination claim made by a customer. This could be a factor that may be significant and important to the owner, but is not known or identified or understood by the owner or the agent. Alternatively, the agent may determine that the current policy only covers storm damage, but does not cover flood damage which could be another important consideration for the owner.

The agent may use information about these gaps to add value by educating the owner, and to sell a new policy which covers these gaps to the owner. Further, this gap analysis demonstrates the agent's knowledge of the industry to the owner, and establishes a basis for a detailed discussion for generating a policy to suit the owner's special needs.

This type of gap analysis also has broad benefits for the insurance carrier of the agent. If gap analysis is consistently and thoroughly performed and documented by agents of the insurance carrier, then the insurance carrier greatly reduces its legal exposure.

For example, an owner may file a lawsuit asserting that the agent negligently forgot to include flood insurance, or neglected to tell the owner about flood insurance as an option. As a defense to the lawsuit, the agent may present a gap analysis which was presented to the owner, and which shows that the previous insurance (the base document) did not include flood insurance, but that the recommended gold standard policy did include flood insurance. The agent may testify that the owner declined the flood insurance portion of the gold standard insurance policy, because the owner did not want to pay the additional premiums (for example, an additional $100/month) associated with the flood insurance portion of the new insurance. Thus, a consistent and systematic use of gap analysis by the insurance agent provides many benefits to the owners, the agent and the carrier. However, current approaches are manual, inconsistent or even erroneous, require extensive industry and insurance knowledge, are expensive to perform, and cause delays.

In a large sale opportunity, an expert may be contracted to perform an analysis. However, this approach is manual, expensive, unsystematic, and only performed on special occasions.

Unfortunately, due to time and budget constraints, commonly the agent will merely make a superficial analysis concentrating only on simple factors such as a price for a policy with identical coverage, or concentrating on deductibles.

Similar to the above discussion, an expert system gap analysis may be performed on health insurance policies with respect to inclusions and exclusions of benefits.

SECOND SCENARIO—INSURANCE BROKER In a second exemplary scenario, a user is an insurance broker hired to solicit bids for a health insurance plan for employees of a small business. The broker generally receives many plans (also known as policies or quotes or proposals) from many insurance carriers, including several plans that are long and detailed with many inclusions and exclusions of benefits pertaining to the coverage level. Typically plans are limited to focus on price, eligibility, enrollment effect date. Problematically, plans can vary substantially even though the plans superficially appear to be similar. The insurance broker may choose a plan due to incentives (such as events, dinners, and bonus programs offered by the insurance carriers) which may compromise the broker's independent judgment.

A good insurance broker wants to ensure he is selecting (or recommending) the best plan for the customer (the small business with employees in this scenario), and also wants to enhance his integrity (and perhaps equally important for a broker, the appearance of integrity) by proving to the customer that the selected plan is the best plan based on a combination of factors which may include: price, benefits, and coverage.

Further, the insurance broker wants to use an objective method or tool which allows the broker to analyze a variety of plans, identify the gaps, and make an informed selection which meets or exceeds the needs of the customer. Utilizing an objective method or tool (such as an expert system for analyzing gaps) has the benefit of reducing legal and E&O (“Errors and Omissions”) exposure and coverage by providing clear documentation of the objective method used to select a plan.

An expert system for analyzing gaps will perform gap analysis consistently, easily, and cost effectively, and therefore can be performed during each broker consultation. Further, the expert system will quickly and automatically compare multiple proposed plans against a single existing plan, or compare multiple proposed plans against a single “gold standard” plan, or directly compare a first proposed plan against a second proposed plan.

THIRD SCENARIO—AGRICULTURAL PRODUCTS In a third exemplary scenario, the user is a salesperson selling agricultural products such as herbicides or pesticides or seed to a farmer. In this scenario, the farmer is evaluating alternatives for the next crop year attempting to increase yield, reduce costs and reduce risk.

For example, the farmer is experiencing a problem with a specific weed growing in a particular soybean field. The farmer is overwhelmed by the vast amounts of detailed chemical and biological data associated with different herbicides, and is unsure which herbicide is the best for his needs. The expert system for gap analysis allows the salesperson to compare herbicide labels (and/or the associated chemical and biological and financial data) and perform an expert system gap analysis on the different herbicides.

In this example, the “document” for gap analysis may include a herbicide label on a herbicide container and/or all of the chemical and biological and financial data associated with the herbicide. The associated data may be available on a website of the herbicide manufacturer, or may be available on a database which combines data from multiple sources.

This expert system gap analysis assists the salesman in offering an informed recommendation to the farmer, and thus aids the farmer in making an informed decision. For example: Brand (A) will work in one application (is sprayed on only one time), but it is the most expensive per application; Brand (B) will also work, but needs rain to fall within five days after application or else needs to be irrigated; Brand (C) will work, but will need three applications.

After expert system gap analysis, the farmer may determine that Brand (A) is the best, because Brand (A) avoids the need for multiple applications (and the associated costs) and avoids the risk of requiring irrigation (and the associated costs). Alternatively, the farmer may determine that Brand (B) is the best, because the farmer was already planning to irrigate the crop in the near future.

Further, performing an expert system gap analysis reduces the salesman's liability by ensuring that the salesman recommends the best product, and improves the salesman's reputation by allowing the salesman to perform an expert analysis (using the expert system) and be seen as an expert. The expert system also helps the salesman to be legal to code. The expert system gap analysis is not limited by the knowledge of any single salesman, but rather utilizes an expert system based on the knowledge of at least one expert, and thus provides a high level of certainty from the expert system gap analysis.

Similarly, the farmer may be concerned about insects, and may perform an expert system gap analysis on pesticides for controlling the insects. Other possible scenarios include performing a gap analysis on health insurance policies with respect to inclusions and exclusions of benefits.

FOURTH SCENARIO—COMPREHENSIVE AGRICULTURAL PLANNING In a fourth exemplary scenario, the user is a salesperson selling a comprehensive combination of agricultural products such as seed, herbicides, fertilizer, insurance and/or financial products to a farmer. The financial products may include crop insurance which effectively provides a hedge against crop failure, and thus reduces risk.

In this scenario, the salesperson and the farmer evaluate comprehensive alternatives for the next crop year with an objective of increasing performance variables such as expected yield and expected net profit (while managing costs and reducing risks).

For example, the farmer would like to improve yields while managing costs and managing risks. The expert system for gap analysis allows the salesperson to compare past results such as yield, costs, and losses due to factors out of the farmer's control (such as drought), and to propose a comprehensive recommendation based on best practices or on a gold standard.

The past results may be represented in documents, databases or web sites in the form of yield maps, as harvested maps, production results, financial statements, satellite images, and a variety of other documents. The gold standard may be represented in test plots, expert analysis, published best practices, regional, national comparisons or benchmarking.

The gaps may be identified with respect to the seed selected, fertility programs, farm practices, and insurance coverage, as well as others factors which may preventing a farmer from maximizing or improving results (such as expected yield and expected net profit) while managing costs and risks.

This expert system gap analysis assists the salesperson in offering an informed and comprehensive recommendation to the farmer, and thus aids the farmer in making an informed decision.

Further, performing an expert system gap analysis reduces the salesperson's legal liability by ensuring that the salesperson recommends the best product for the farmer's specific situation, and improves the salesperson's reputation by allowing the salesperson to perform an expert analysis (using the expert system) and be recognized as an expert. The expert system gap analysis is not limited by the knowledge of any single salesperson, but rather may utilize an expert system based on the knowledge of multiple experts, and thus provides a high level of certainty from the expert system gap analysis.

Other possible scenarios include performing a gap analysis on financial products or crop insurance policies.

Previous to this disclosure, there was no expert system for analyzing a gap by determining a first parameter from a base document, a second parameter from a target document, a difference magnitude between the first parameter and the second parameter, and a subject score as a function of the difference magnitude and a subject importance. Using the disclosed expert system, gap analysis can be performed consistently, easily, and cost effectively.

### SUMMARY OF THE INVENTION

According to one aspect of the invention, a method comprises selecting a base document for analysis, selecting a target document for analysis, selecting a subject for analysis, analyzing the base document and the target document with respect to the subject, determining a gap in the base document in comparison with the target document with respect to the subject, and outputting the gap, wherein the analyzing and the determining are performed automatically using a computer.

According to other aspects of the invention, the method may determine a gap in the base document in comparison with the target document with respect to the subject, wherein the determining a gap includes determining at least a first parameter from the identified portion of the base document and at least a second parameter from the identified portion of the target document, and further includes subtracting the first parameter from the second parameter to determine a difference magnitude associated with the subject.

According to other aspects of the invention, the method may determine a subject score for the subject, wherein the subject score is a function of both the difference magnitude and a subject importance factor, and wherein the subject importance factor indicates an importance of the subject.

Other exemplary embodiments and advantages of the present invention may be ascertained by reviewing the present disclosure and the accompanying drawings.

### BRIEF DESCRIPTION OF THE DRAWINGS

This disclosure is further described in the detailed description which follows, in reference to the noted plurality of drawings by way of non-limiting examples of embodiments of the present disclosure, in which like reference numerals represent similar parts throughout the several views of the drawings.

FIG. 1 illustrates a conventional manual process for manually determining gaps.

FIG. 2 illustrates an exemplary embodiment of a method of using an Expert System to analyze documents, determine a gap, and determine a subject score.

FIG. 3 illustrates an exemplary screen shot of an Expert System for selecting documents.

FIG. 4 illustrates an exemplary screen shot of an Expert System configured to select specific documents from a group of documents.

FIG. 5 illustrates an exemplary screen shot of an Expert System configured to perform a gap analysis between a base document (“Current Policy”) and a target document (“Gold Standard”).

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

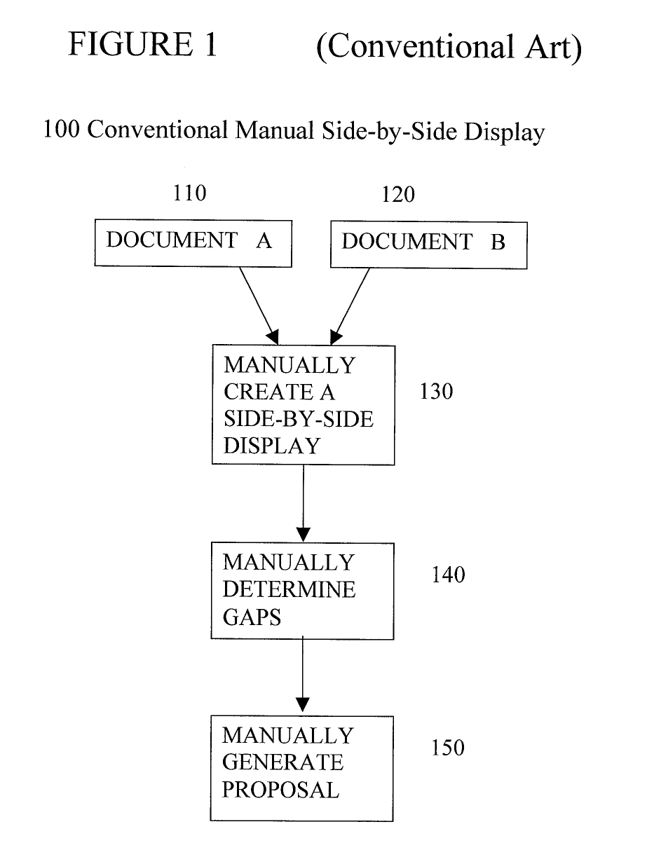

FIG. 1 illustrates a conventional manual process for manually determining gaps 100. Document A 110 and Document B 120 are manually reviewed, and portions of each document are manually assembled to create a side-by-side display 130. The display is manually evaluated to determine gaps between the displayed portions 140. The determined gaps are used to manually generate a proposal for a potential client 150.

The term “manually” means that a person (a human being) must perform an action without the assistance of an Expert System. For example, in FIG. 1 an agent must visually (“manually”) read the documents, and must personally and individually (“manually”) select portions to display. Manual processes are very time consuming, expensive, and notoriously inconsistent.

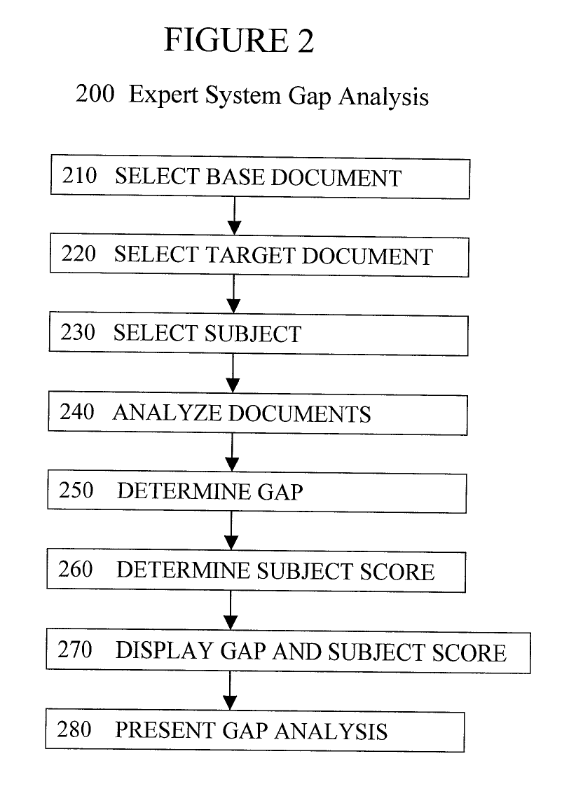

FIG. 2 illustrates an exemplary embodiment of a method of using an Expert System 200 to analyze documents, determine a gap, and determine a subject score. At 210, a base document is selected by a user. At 220, a target document is selected by the user. For example, as discussed above in the first scenario, the base document can be an existing insurance policy of a potential client, and the target document can be a gold standard insurance policy.

At 230, the user can select a subject for analysis. The user can select multiple subjects for analysis from a menu. For example, the subject can be flood coverage.

Alternatively, this selection can be performed automatically by the Expert System according to one aspect of the present invention. For example, the Expert System can automatically analyze the document for terminology or subject matter (using word search and/or more advanced search features and/or artificial intelligence features), can automatically determine that the base document is an insurance policy, and can automatically select a first predetermined group of subjects for analysis. The Expert System can also automatically determine what type of insurance policy (car, business, home, boat, etc) is being analyzed, and can automatically select a second predetermined group of subjects for analysis if the insurance policy is for a car, and can automatically select a third predetermined group of subjects if the insurance policy is for a boat.

Additionally, the Expert System can automatically present the selected predetermined group of subjects to the user in the form of a menu, so that the user can further selectively narrow the field of analysis to one or two subjects (within the selected predetermined group of subjects) which can be more important in this particular case for this particular user.

At 240, the Expert System then automatically analyzes the documents by identifying portions or information in each document which are associated with each selected subject. If no associated portion in a document is found, then the Expert System can record that no associated portion was found. The information that no associated portion was found is very important, and is very difficult to obtain by manual methods, if not impossible.

In a manual process, a reader generally must read the entire document several times to be relatively certain that no portion is associated with a given subject. Subject headings and titles are often misleading, incomplete, use different terms, or are even incorrect. A reader cannot rely on the subject headings, and must actually read the text in the paragraphs to be certain. Therefore, manually determining that a given subject is not present in a document (known as proving a negative) is a very difficult task to perform.

At 250, the Expert System determines a gap for each selected subject. The gap can be numerical (as a base level of analysis). For example, flood coverage in the target document can be $1,000,000 (a first parameter), whereas no flood coverage portion is present in the base document. The Expert System can define no flood coverage being present in the base document as having a default value of $0 (a second parameter). Thus, a gap can be calculated by subtracting $0 from $1,000,000, which yields a gap (a difference in magnitude obtained by subtracting the second parameter from the first parameter) of $1,000,000 for the subject of flood coverage.

In the unlikely event that the base document provides greater coverage (for example, $1,500,000 of flood insurance) than the target document ($1,000,000 of flood insurance), then the calculated gap will be negative $500,000. In this unlikely event, the Expert System can simply state that there is no gap, or state that there is a gap of $0, or can state that there is a “negative” gap (a gap of negative $500,000) indicating over-coverage, or may request that a different target document should be selected with greater coverage. Over-coverage may indicate an opportunity to save money for the potential client by reducing coverage to a more reasonable amount, as suggested by the target document (which can be the “gold standard”). A more sophisticated use of this capability is to take a coverage, for example the discrimination gap identified earlier in the document, and define a numeric value to this discrimination gap.

At 260, the Expert System can determine a subject score for each selected subject. The subject score may be a function of the gap and of a subject importance factor. The subject importance factor indicates how important the selected factor is in the context of the selected documents. For example, flood insurance in a home insurance policy for a home located in New Orleans, Miss. may be very important. On the other hand, flood insurance in a home insurance policy for a home located in Las Vegas, Nev. may not be important. The reverse may be true for fire insurance.

In one embodiment, the subject importance factor can have a value from 0 to 1. For example, flood insurance can have an importance factor of 1, and fire insurance can have an importance factor (or weighting factor) of 0.5. Thus, an Expert System determination of a gap in flood insurance of $500,000 times an importance factor of 1.0 yields a subject score of 500,000. Further, the Expert System can classify a subject score of 500,000 as very bad, and can use an icon such as a red exclamation point (“!”) to indicate a very bad subject score. In other words, the subject score can be classified and can be represented by an icon. For example, the subject score can be classified as expensive to inexpensive, or high to low risk. All types of classifications are possible.

Similarly, an Expert System analysis of a gap in fire insurance of $500,000 times an importance factor of 0.5 yields a subject score of 250,000. The Expert System can classify a subject score of 250,000 as bad, and can use an icon such as a yellow circle to indicate a bad subject score.

Further, a determination of no gap can be classified as neutral, and can be represented by an empty circle icon. Additionally, a determination of over-coverage can be classified as good, and can be represented by a green question mark (“?”) icon. Other classifications and other icons can be used. For example, colored flag icons may be used (gold/silver/bronze like Olympic medals, or green/yellow/red like streetlights).

In 270, the Expert System can display the gap of any selected subject, and/or the subject score of any selected subject. As discussed above, the subject score can also be represented by icons. Further, the expert system has learning capabilities and will better learn over time what is important and what is not important. By using these learning capabilities, only the important gaps are identified as the expert system learns.

In 280, the user can present the gap analysis (including the subject score) to a potential client. Before presenting, the user can manually perform additional analysis. For example, the user can simplify the determined results (gap and subject score) by deleting the subjects which resulted in no gap or which resulted in over-coverage. As discussed above, the Expert System learns from interactions with the user. Additionally, the user can insert information from the gap analysis into a formal written proposal for presentation to the potential client.

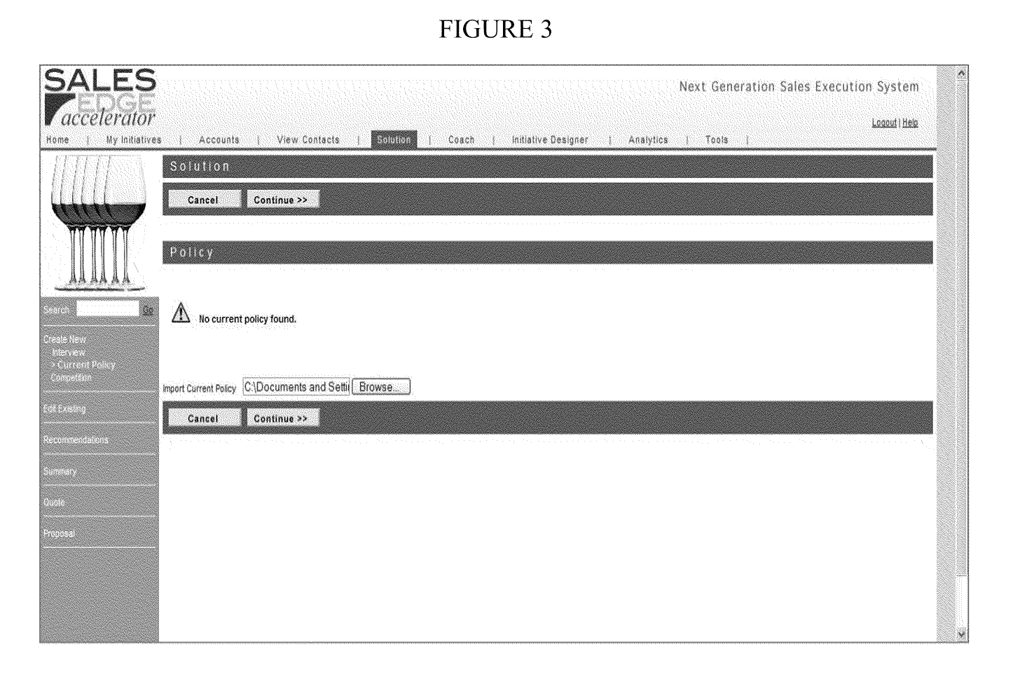

FIG. 3 illustrates an exemplary screen shot of an Expert System configured to select documents. A base document such as a current policy can be entered by browsing a storage system and importing selected documents into the Expert System. Further, a printed document may be scanned, and converted into an electronic document for analysis.

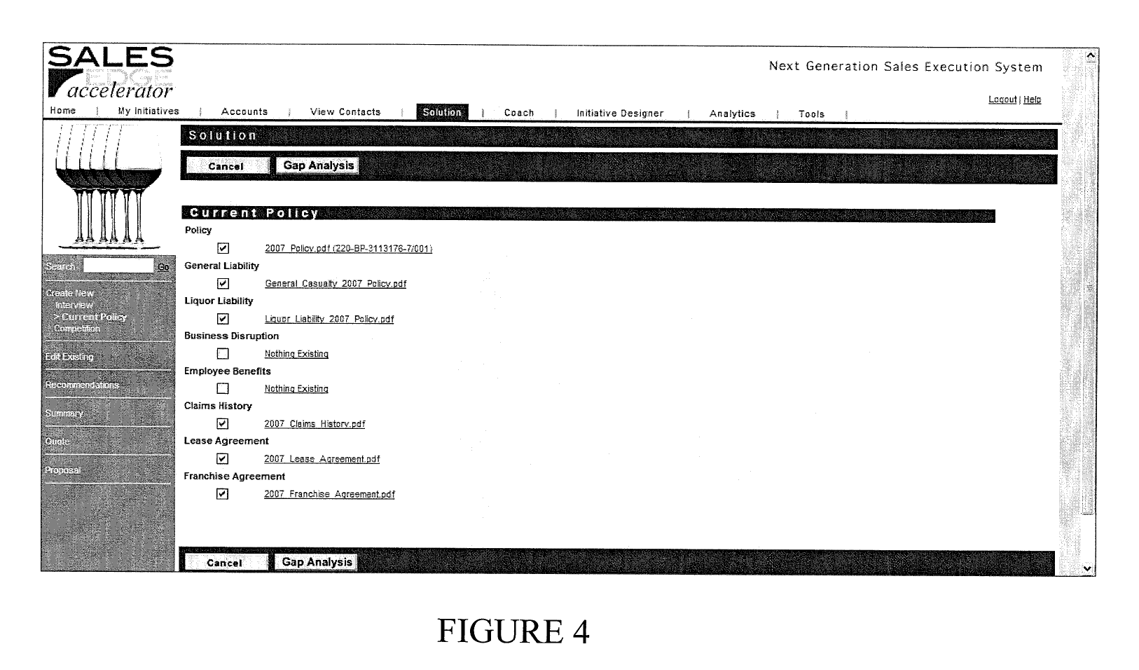

FIG. 4 illustrates an exemplary screen shot of an Expert System configured to select specific documents from a group of documents for analysis.

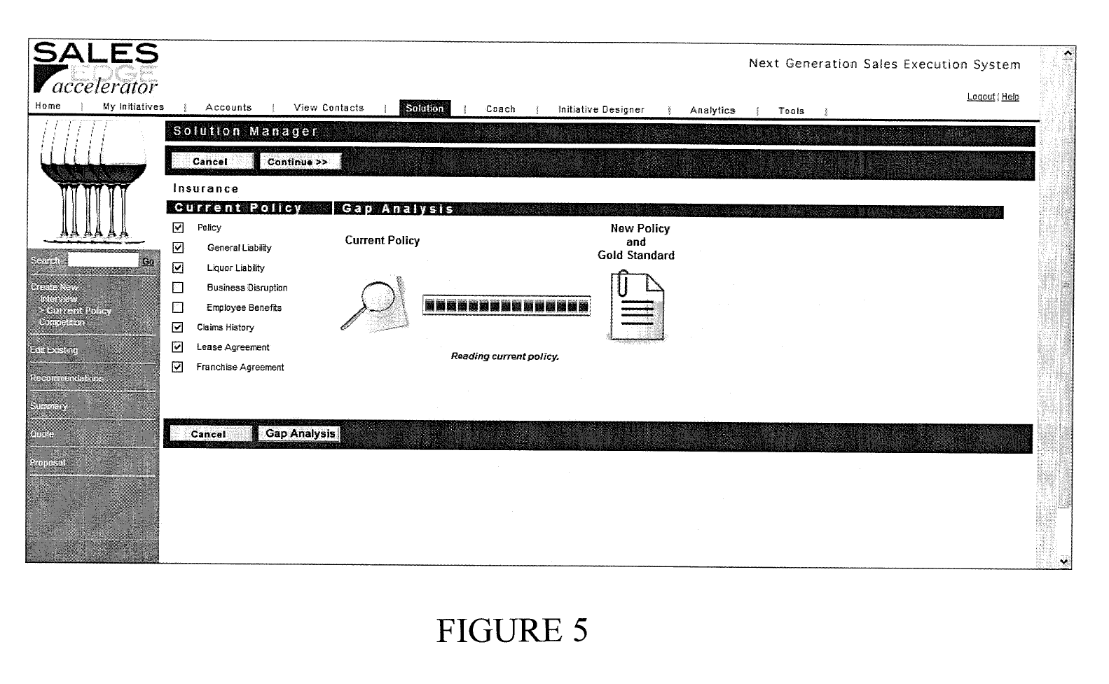

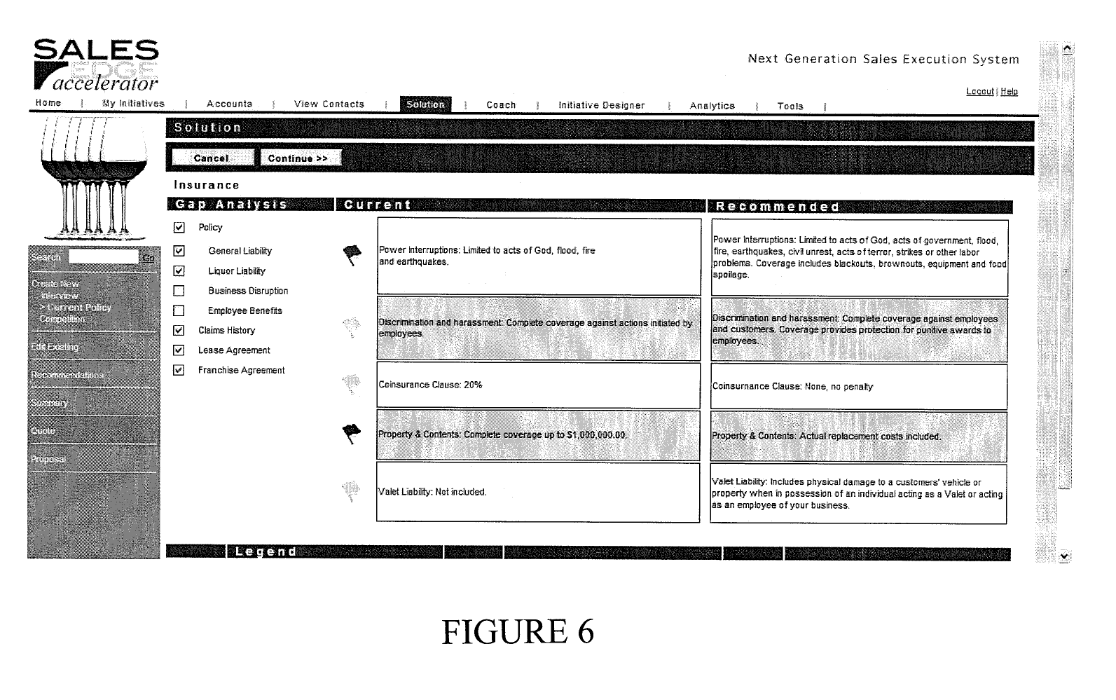

FIG. 5 illustrates an exemplary screen shot of an Expert System configured to perform a gap analysis between a base document (“Current Policy”) and a target document (“Gold Standard”).

FIG. 6 illustrates an exemplary screen shot of an Expert System configured to display portions of the base document (in the “Current” column) which are associated with subjects where gaps were identified, and portions of the target document (in the “Recommended” column) which are associated with subjects where gaps were found.

For example, Power Interruptions in the base document (“Current”) are very narrowly limited to “acts of God, flood, fire, and earthquakes.” In contrast, the Power Interruptions in the target document (“Recommended”) very broadly cover “acts of God, acts of government, flood, fire, earthquakes, civil unrest, acts of terror, strikes or other labor problems.”

Additionally, the Expert System has placed a dark flag icon next to the Power Interruptions, indicating a high subject score for this gap in the subject of Power Interruptions. Thus, the shade or color of the flag icon may serve as an indictor of the subject score determined by the Expert System for the subject of Power Interruptions.

The foregoing examples have been provided merely for the purpose of explanation and are in no way to be construed as limiting of the present disclosure. While the present disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed:

1. A computerized expert method for gap analysis, the method comprising:
selecting a base document for analysis;
selecting a target document for analysis;
selecting a subject for analysis;
analyzing the base document and the target document with respect to the subject;
determining a gap in the base document in comparison with the target document with respect to the subject; and
outputting the gap,
wherein the analyzing and the determining are performed automatically using a computer.

2. The computerized expert method of claim 1, wherein the base document and the target document are insurance policies.

3. The computerized expert method of claim 1, wherein the base document and the target document are agricultural products.

4. The computerized expert method of claim 1, further comprising:
presenting a list of subjects to a user;
selecting, by the user, at least one subject from the list of subjects; and
analyzing the base document and the target document with respect to the selected subject.

5. The computerized expert method of claim 1, wherein the analyzing includes using a word search function to identify a portion of the base document associated with the selected subject, and to identify a portion of the target document associated with the selected subject.

6. The computerized expert method of claim 5, wherein the determining includes determining at least a first parameter from the identified portion of the base document and at least a second parameter from the identified portion of the target document.

7. The computerized method of claim 6, wherein the determining further includes subtracting the first parameter from the second parameter to calculate a difference magnitude associated with the subject.

8. The computerized method of claim 7, further comprising:
determining a subject score for the subject, wherein the subject score is a function of both the difference in magnitude and a subject importance factor, and wherein the subject importance factor indicates an importance of the subject;
and outputting the subject score.

9. The computerized expert method of claim 5, wherein the word search function utilizes lists of synonyms.

10. The computerized expert method of claim 1, wherein the analyzing includes using concept searching to identify a portion of the base document associated with the selected subject, and to identify a portion of the target document associated with the selected subject.

11. The computerized method of claim 1, wherein the analyzing is performed using concept based analysis and classification, and wherein the concept based analysis and classification utilize domain knowledge.

12. The computerized method of claim 1, further comprising:
learning and growing the expert system over time.

13. The computerized expert method of claim 1, further comprising:
generating an icon associated with the determined gap, wherein a size or a shape or a color of the icon graphically provides information regarding a classification or a size or an importance or a ranking of the gap.

14. A computer-readable storage medium containing expert system instructions which cause an expert system computer to execute the following:
selecting a base document for analysis;
selecting a target document for analysis;
selecting a subject for analysis;
analyzing the base document and the target document with respect to the subject;
determining a gap in the base document in comparison with the target document with respect to the subject; and
outputting the gap,
wherein the analyzing and the determining are performed automatically using the expert system computer.

15. A computer-readable storage medium of claim 14, wherein the base document and the target document are insurance policies.

16. The computer-readable storage medium of claim 14, wherein the base document and the target document are agricultural products.

17. The computer-readable storage medium of claim 14, further comprising:
presenting a list of subjects to a user;
selecting, by the user, at least one subject from the list of subjects; and
analyzing the base document and the target document with respect to the selected subject.

18. The computer-readable storage medium of claim 14, wherein the analyzing includes using a word search function to identify a portion of the base document associated with the selected subject, and to identify a portion of the target document associated with the selected subject.

19. The computer-readable storage medium of claim 18, wherein the determining includes determining at least a first parameter from the identified portion of the base document and at least a second parameter from the identified portion of the target document.

20. The computer-readable storage medium of claim 19, wherein the determining further includes subtracting the first parameter from the second parameter to calculate a difference magnitude associated with the subject.

21. The computer-readable storage medium of claim 20, further comprising:
determining a subject score for the subject, wherein the subject score is a function of both the difference in magnitude and a subject importance factor, and wherein the subject importance factor indicates an importance of the subject;
and outputting the subject score.

22. The computer-readable storage medium of claim 18, wherein the word search function utilizes lists of synonyms.

23. The computer-readable storage medium of claim 14, wherein the analyzing includes using concept searching to identify a portion of the base document associated with the selected subject, and to identify a portion of the target document associated with the selected subject.

24. The computer-readable storage medium of claim 14, wherein the analyzing is performed using concept based analysis and classification, and wherein the concept based analysis and classification utilize domain knowledge.

25. The computer-readable storage medium of claim 14, further comprising:
learning and growing the expert system over time.

26. The computer-readable storage medium of claim 14, further comprising:
generating an icon associated with the determined gap, wherein a size or a shape or a color of the icon graphically provides information regarding a classification or a size or an importance or a ranking of the gap.

27. An expert system comprising:
a first selector configured to select a base document for analysis;
a second selector configured to select a target document for analysis;
a third selector configured to select a subject for analysis;
an analyzer configured to analyze the base document and the target document with respect to the subject;
a determiner configured to determine a gap in the base document in comparison with the target document with respect to the subject; and
an outputter configured to output the gap,
wherein the analyzing and the determining are performed automatically.

28. A computerized expert method for gap analysis, comprising:
selecting a base document for analysis;
selecting a target document for analysis;
selecting a subject for analysis;
analyzing the base document and the target document with respect to the subject;
determining a gap in the base document in comparison with the target document with respect to the subject, wherein the determining a gap includes determining at least a first parameter from the identified portion of the base document and at least a second parameter from the identified portion of the target document, and further includes subtracting the first parameter from the second parameter to determine a difference magnitude associated with the subject;
outputting the gap;
determining a subject score for the subject, wherein the subject score is a function of both the difference magnitude and a subject importance factor, and wherein the subject importance factor indicates an importance of the subject; and
outputting the subject score; and
wherein the analyzing step and the determining a gap step are performed automatically using a computer.
